(19) United States
(12) Patent Application Publication
(10) Pub. No.: US 2023/0205525 A1
(43) Pub. Date: Jun. 29, 2023

(54) LOAD AND STORE MATCHING BASED ON ADDRESS COMBINATION

(71) Applicant: ADVANCED MICRO DEVICES, INC., Santa Clara, CA (US)

(72) Inventor: Sadayan Ghows Ghani Sadayan Ebramsah Mo Abdul, Austin, TX (US)

(21) Appl. No.: 17/564,173

(22) Filed: Dec. 28, 2021

(51) Int. Cl. G06F 9/30

(52) U.S. Cl. CPC G06F 9/30043

(57) ABSTRACT

A processor identifies matches between a load operation and a plurality of more store operations based on an address vector that represents a combination of addresses targeted by the store operations. The address vector is used to identify a potential match between an address targeted by the load operation and at least one of the addresses targeted by the plurality of store operations. This allows the processor to quickly identify when there are no potential matches between the load operation and any of the plurality of store operations, thereby reducing overhead at the processor and improving overall processing efficiency.

### BACKGROUND

A processing system typically includes a processor that, among other operations, executes memory operations (load operations and store operations) to retrieve data from and store data at memory modules of the processing system. To manage these memory operations, some processors include a load-store unit (LSU). The LSU receives and queues both load and store operations and interfaces with the memory modules to execute the queued memory operations. In some cases, it is useful for the LSU to identify when a received load operation targets a same memory address as one or more queued store operations. For example, some LSUs are configured to perform store-to-load forwarding (STLF) operations, wherein data to be stored for a particular queued store operation is provided, or forwarded, to a received load operation that targets the same memory address. STLF operations are employed to ensure proper execution of the load operation and to enhance processing efficiency, as the load operation is able to be satisfied relatively quickly. However, existing techniques for identifying when a load operation and a store operation target the same memory address have relatively high overhead, and negatively impact the efficiency of the LSU.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processor including a load-store unit (LSU) that identifies potential matches between a load operation and a plurality of store operations based on a combination of the store operations in accordance with some embodiments.

FIG. 2 is a block diagram of an address match module of the LSU of FIG. 1 in accordance with some embodiments.

FIG. 3 is a diagram illustrating examples of the address match module of FIG. 2 identifying potential address matches between a load operation and a plurality of store operations in accordance with some embodiments.

FIG. 4 is a flow diagram of a method of identifying matches between a load operation and a plurality of store operations to perform store-to-load forwarding in accordance with some embodiments.

### DETAILED DESCRIPTION

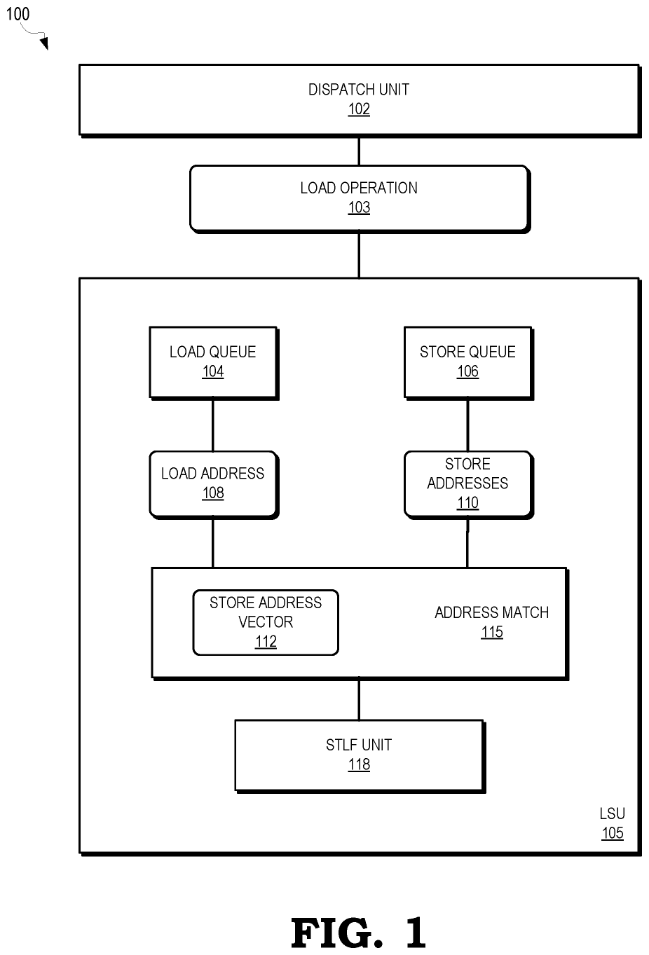

FIGS. 1-4 illustrate techniques for identifying, at a processor, matches between a load operation and a plurality of more store operations based on an address vector that represents a combination of addresses targeted by the store operations. The address vector is used to identify a potential match between an address targeted by the load operation and at least one of the addresses targeted by the plurality of store operations. This allows the processor to quickly identify when there are no potential matches between the load operation and any of the plurality of store operations, thereby reducing overhead at the processor and improving overall processing efficiency.

To illustrate, when a load-store unit (LSU) of a conventional processor receives a load operation, the LSU compares the address targeted by the load operation (referred to as the load address) to each of a plurality of addresses targeted by a corresponding plurality of pending store operations (referred to as store addresses). In response to identifying a match between the load address and a store address, the LSU performs one or more specified tasks, such as forwarding data associated with the corresponding store operation to the load operation. However, in a large majority of cases, the load address will not match any of the store addresses for the pending store operations, and the set of compare operations therefore consumes processing overhead without providing a commensurate benefit.

In contrast to this conventional approach, using the techniques disclosed herein an LSU generates an address vector responsive to receiving the load operation, wherein the address vector represents a combination of the store addresses for the plurality of store operations. For example, in some embodiments the LSU generates the address vector by performing an OR operation for each corresponding bit of the store addresses. The LSU compares the load address to the address vector and determines if each bit of the load address having a specified value (e.g., a logic value of “1”) matches the corresponding bit of the address vector. If so, the LSU determines that there is a potential match between the load address and one of the store addresses and proceeds to compare the load address to each of the store addresses individually, to identify the matching store operation (if any). If at least one bit of the load address having the specified value does not match the corresponding bit of the address vector, the LSU determines that there is no potential match between the load operation and any of the store operations. Thus, using the address vector, the LSU is able to quickly determine when there is no match between a load operation and a set of queued store operations, reducing overhead at the LSU and improving overall efficiency at the processor.

FIG. 1 illustrates a block diagram of a processor 100 that is generally configured to identify potential matches between a load operation and a plurality of store operations based on a combination of the store operations in accordance with some embodiments. In different embodiments, the processor 100 is incorporated into one of a variety of different types of electronic device, such as a desktop computer, laptop computer, server, smartphone, tablet, game console, and the like. The processor 100 is generally configured to execute sets of instructions to carry out specified tasks on behalf of the electronic device. Accordingly, for purposes of description of FIG. 1, it is assumed that the processor 100 is a central processing unit (CPU). However, in other embodiments the processor 100 is a different type of processing unit, such as a graphics processing unit (GPU), an accelerated processing unit (APU), and the like, or any combination thereof.

To facilitate execution of instructions, the processor 100 includes at least one instruction pipeline having a dispatch unit 102 to dispatch operations, including memory operations, to one or more execution units. In some embodiments, the instruction pipeline includes additional stages and units not illustrated at FIG. 1, such as a fetch unit to fetch instructions from an instruction queue, a decode unit to decode the fetched instructions into one or more operations that are provided to the dispatch unit 102, execution units to execute the dispatched operations, and a retire stage to retire instructions whose operations have completed execution.

As noted above, in at least some cases the instruction pipeline generates memory operations, such as store operations and load operations (e.g., load operation 103). To execute the memory operations, the processor 100 includes a load-store unit (LSU) 105. The LSU 105 is generally configured to receive memory operations from the dispatch unit 102, or from other modules of the processor 100 (e.g., from another execution unit), to queue the memory operations, to provide control signaling to a memory controller to execute the memory operations, and to provide data responsive to the memory operations (e.g., load data) to one or more registers (not shown) of the processor 100.

To improve processing efficiency and to ensure proper execution of memory operations, the LSU 105 is generally configured to perform store-to-load forwarding (STLF) wherein data from a store operation that targets the same memory address as a load operation is provided (that is, forwarded) to the load operation. To illustrate, the LSU 105 receives from the dispatch unit 102 memory operations (load operations and store operations), wherein each memory operation includes a physical address indicating the memory location targeted by the memory operation. Thus, each load operation includes a physical address indicating the memory location from which data (referred to as the load data) is to be retrieved, and each store operation includes data to be stored (referred to as the store data) a physical address indicating the memory location where the store data is to be stored. The LSU 105 includes a load queue 104 to store each pending load operation and a store queue 106 to store each pending store operation.

In response to receiving a load operation, the LSU 105 employs an address match module 115 to identify any match between the load operation 103 and the store operations queued at the store queue 106, a process referred to herein as finding a matching store for the load operation. In some embodiments, the address match module 115 employs a two-stage process to identify a matching store: first, the address match module 115 determines if there is a potential match between the load operation 103; second, the address match module 115 either ends the match process (if no potential match is indicated) or proceeds to determine a store match based on a comparison of the load address to each of the store addresses 110 (if a potential match is indicated).

To determine the potential match, the address match module 115 determines an address vector 112 by combining a set of store addresses 110. In some embodiments, the address match module first identifies the set of store addresses 110 from a larger set of store addresses stored at the store queue 106 and based on a subset of bits of the load address 108. For example, in some embodiments, the address match module identifies the store addresses 110 based on selected bits of the store addresses 110 match corresponding bits of the load address 108.

To generate the store address vector 112, the address match module 115 combines the store addresses 110, such as by logically combining corresponding bits of each of the store addresses 110. For example, in some embodiments the address match module 115 generates the address vector 112 by performing a logical OR operation for each corresponding bit of the store addresses 110. Thus, the address match module 115 generates a zeroth bit (a bit at position zero) of the address vector 112 by performing a logical OR operation using the zeroth bit of each of the store addresses 110, generates a first bit (a bit at position one) of the address vector 112 using the first bit of each of the store addresses 110, and so on.

To determine if there is a potential match, the address match module 115 compares each bit of the load address 108 that has a specified value, such as a logic value of “1”, to a corresponding bit of the address vector 112. If each of the compared bits match, the address match module 115 determines that there is a potential match between the load address 108 and one or more of the store addresses 110. If there is a mismatch between at least one of the compared bits, the address match module 115 determines that there is no potential match between the load address 108 and the store addresses 110, and therefore determines that the load operation 103 does not match any of the store operations queued at the store queue 106. The address match module 115 is thus able to quickly and efficiently identify when there is no potential match, lowering overhead at the LSU 105 and improving the overall efficiency of the processor 100.

If the address match module 115 determines that there is a potential match, the address match module 115 proceeds to compare the load address 108 to each of the store addresses 110. In response these comparisons identifying a store address that matches the load address 110, the address match module identifies the store operation at the store queue 106 that matches the load address 108, and therefore that matches the load operation 103. The address match module 115 provides an indication of the matching store operation to an STLF unit 118, which forwards the data from the matching store operation to the load operation 103. For example, in some embodiments the STLF unit 118 retrieves the store data of the matching store from the corresponding entry of the store queue 106 and copies the store data to the entry of the load queue 104 corresponding to the load operation 103. The LSU 105 then provides the load data (the data that has been forwarded from the matching store operation) to a register of the processor 100, thus completing execution of the load operation 103.

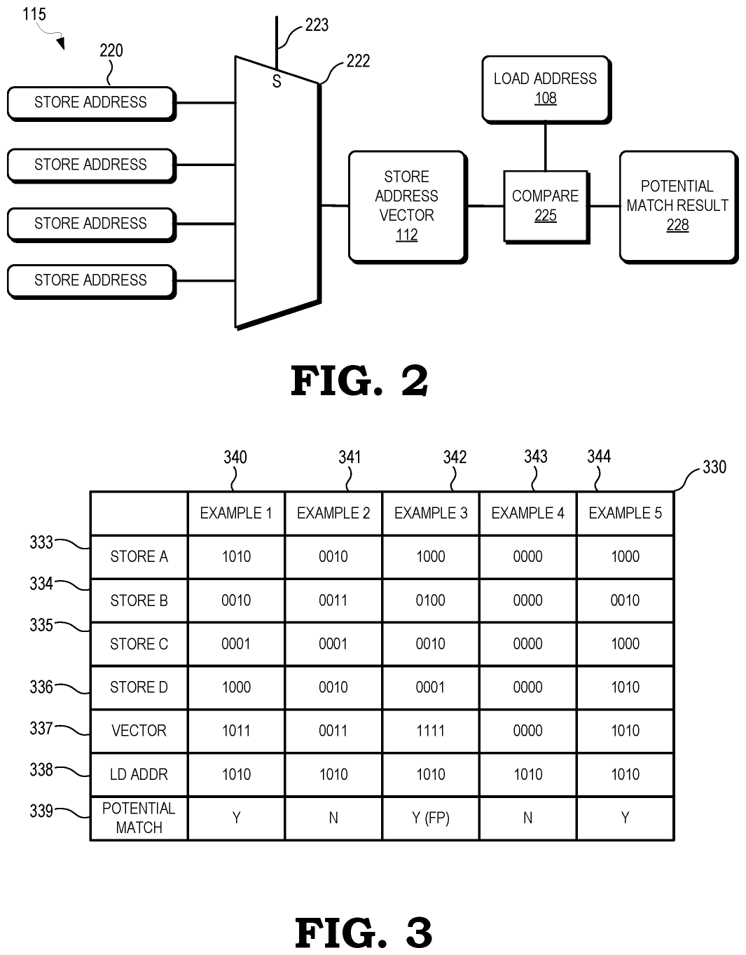

FIG. 2 illustrates a block diagram of the address match module 115 in accordance with some embodiments. In the depicted example, the address match module 115 includes a multiplexer 222 and a compare module 225. The multiplexer 222 is generally configured to logically combine the plurality of store addresses (e.g., store address 220) that compose the store addresses 110 (FIG. 1), thereby generating the address vector 112. In particular, the multiplexer 222 includes a select input (S) 223 that determines how the input store addresses are selected. Applying a “one-hot” select signal (that is, a select signal having only one asserted bit) at the select input 223 causes the multiplexer 222 to select the bits of one of the input store addresses to be provided at the output of the multiplexer 222. However, by applying a “multi-hot” select signal (that is, a select signal having multiple asserted bits) at the select input 223, the address match module 115 causes the multiplexer 222 to provide, at the output, the logical OR combination of the selected ones of the input store addresses. Accordingly, the address match module 115 applies a select signal at the select input 223 so that each of the input store addresses is selected by the multiplexer 222. This generates the address vector 112 so that each bit of the vector is the logical OR combination of the corresponding bits of each of the input store addresses.

The compare module 225 compares each bit of the load address 108 having a specified state, such as an asserted state or a digital value of “1”, with the corresponding bit of the address vector 112 and, based on the comparison, generates a potential match result 228, indicating whether there is a potential match between the load address 108 and one or more of the store addresses at the input of the multiplexer 222. For example, in some embodiments, if each bit of the load address 108 having the specified state matches a corresponding bit of the store address vector 112, the compare module 225 generates the potential match result 228 to indicate a potential match. If any bit of the load address 108 having the specified state does not match a corresponding bit of the store address vector 112, the compare module 225 generates the potential match result 228 to indicate there is not a potential match.

FIG. 3 is a diagram of a table 330 depicting different examples of the address match module 115 generating the potential match result 228. The table 330 includes six columns, with the first column indicating a row title and the remaining columns, designated columns 340-344, indicating data corresponding to a different example, designated Examples 1-5, of the match module 115 generating the potential match result, with each example based on a different set of store addresses 110. The table 330 includes seven rows, with the top row indicating the example number, and the remaining six rows, designated rows 333-339, corresponding to a different aspect of each example. In particular, rows 333, 334, 334, and 336 each indicate a different one of the store addresses 110, designated Store A, Store B, Store C, and Store D, respectively. Row 337 indicates the value of the address vector 112 generated based on the corresponding store addresses. The row 338 indicates the value for the load address 108. As shown, for each of the Examples 1-5, the load address 108 has a value of 1010. The row 339 shows, for each example, whether the potential match result 228 indicates a potential match between the load address and one or more of the store addresses 110.

Turning to Example 1, at column 340, the values for the store addresses 110 are 1010, 0010, 0001, and 1000. The multiplexer 222 generates the address vector 112 by performing a logical OR operation for each corresponding bit of the different address values, resulting in an address vector value of 1011, as shown at row 337. The compare module 225 compares each bit of the load address 108 having a value of 1 with the corresponding bit of the address vector 112. For purposes of description, the zeroth bit of the load address 108, at the rightmost position, has a value of zero, the first bit of the load address 108 (immediately to the left of the zeroth position) has a value of 1, the second bit of the load address 108 has a value of zero, and the third bit of the load address has a value of 1. Thus, the compare module 225 compares the first and third bits of the load address 108, because these bits have a value of 1, to the first and third bits of the address vector 112. In the case of Example 1, the values at the indicated bit positions match. Accordingly, the potential match result 228 indicates a potential match, as shown at row 339. In response to the indication of the potential match, the address match module 115 compares each of the store addresses (that is, each of Store A, Store B, Store C, and Store D), to the load address 108. For Example 1, the address match module 115 determines using a slower multi-cycle age based compare mechanism that compares each of the store addresses to the load address that the store address for Store A matches the load address 108, and in response sends signaling to the STLF unit 118 to forward the store data for Store A to the load operation 103.

With respect to Example 2, at column 341, the values for the store addresses 110 are 0010, 0011, 0001, and 0010, respectively. Accordingly, the logical OR operation by the multiplexer 222 generates the address vector 112 to have a value of 0011, as shown at row 337. The compare module 225 compares each bit of the load address 108 having a value of 1 with the corresponding bit of the address vector 112. As explained above, for the load address 108, the bits at the first and third positions are compared. In the case of Example 2, the value of the address vector 112 at the third bit position is zero, and therefore does not match the load address 108. Accordingly, as shown at row 339, the potential match result 228 indicates there is not a potential match between the load address 108 and any of the store addresses 110. In response, the address match module 115 ends the matching process for the load operation 103. Thus, for Example 2, the address match module 115 determines that there is no match without comparing each of the store addresses 110, individually, with the load address 108, thereby reducing the overhead associated with the matching process.

With respect to Example 3, at row 342, the values for the store addresses 110 are 1000, 0100, 0010, 0001, respectively. Accordingly, the logical OR operation by the multiplexer 222 generates the address vector 112 to have a value of 1111, as shown at row 337. Similar to Examples 1 and 2, the compare module 225 compares the bits at the first and third positions of the load address 108 with the address vector 112. In the case of Example 2, the values at the indicated bit positions match. Accordingly, the potential match result 228 indicates a potential match, as shown at row 339. In response to the indication of the potential match, the address match module 115 compares each of the store addresses. However, for Example 3, the address match module 115 determines that none of the store addresses 110 matches the load address 108, indicating that the potential match result 228 was a false positive (Indicated as FP in row 39). Accordingly, the address match module does not, indicate to the STLF unit 118 that any data is to be forwarded to the load operation 103. Thus, Example 3 shows that the two stage address matching process does not result in incorrect data being forwarded to a load operation, even when the potential match result 228 indicates a potential match.

With respect to Example 4, at column 343, the values for the store addresses 110 are each 0000. Accordingly, the logical OR operation by the multiplexer 222 generates the address vector 112 to also have a value of 0000, as shown at row 337. The compare module 225 compares each bit of the load address 108 having a value of 1 with the corresponding bit of the address vector 112 and determines that neither of the bits at the first and third positions match. Accordingly, as shown at row 339, the potential match result 228 indicates there is not a potential match between the load address 108 and any of the store addresses 110.

For Example 5, at column 344, the values for the store addresses 110 are 1000, 0010, 1000, and 1010, respectively. Accordingly, the logical OR operation by the multiplexer 222 generates the address vector 112 to have a value of 1010, as shown at row 337. The compare module 225 compares each bit of the load address 108 having a value of 1 with the corresponding bit of the address vector 112 and determines that the values at the indicated bit positions match. Accordingly, the potential match result 228 indicates a potential match, as shown at row 339. In response to the indication of the potential match, the address match module 115 compares each of the store addresses to the load address 108 and determines that the store address for Store D matches the load address 108. In response, the address match module 115 sends signaling to the STLF unit 118 to forward the store data for Store A to the load operation 103.

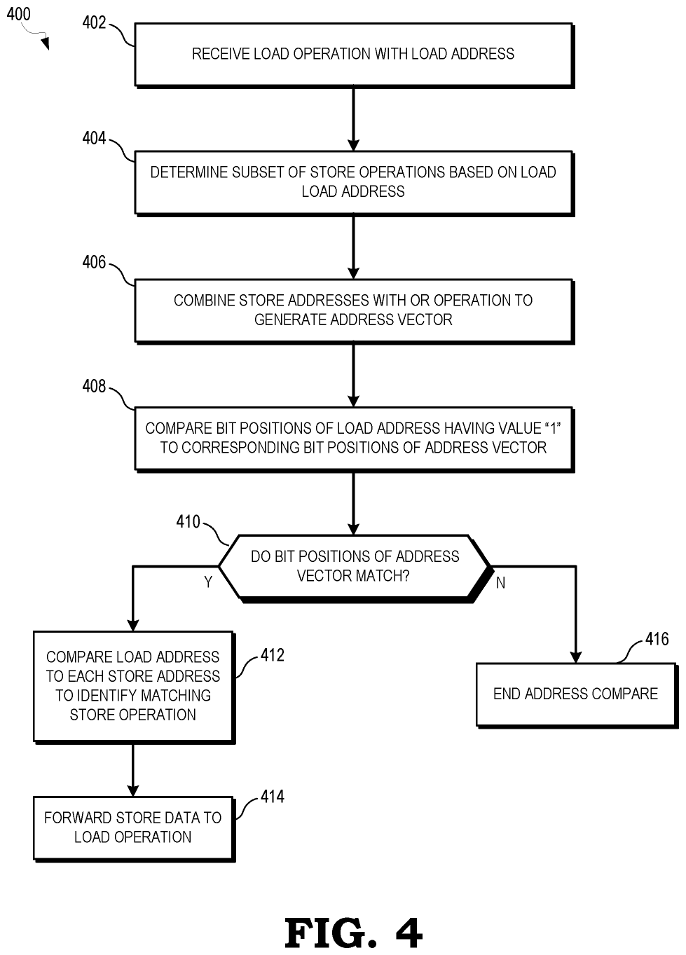

FIG. 4 illustrates a flow diagram of a method 400 of performing matching between a load operation and a plurality of store operations in accordance with some embodiments. For purposes of description, the method 400 is described with respect to an example implementation at the processor 100 of FIG. 1, but it will be appreciated that in other embodiments the method 400 is implemented at processors and processing systems having different configurations.

At block 402, the LSU 105 receives the load operation 103, which includes the load address 108. In response, at block 404, the address match module 115 determines, based on the load address, a subset of the store operations that are queued at the store queue 106. For example, in some embodiments the address match module 115 identifies each store operation having a store address with a specified subset of bits that match the corresponding subset of bits of the load address 108, such as the N least significant bits of each address, where N is an integer. The address match module 115 includes each of these identified store operations in the subset of store operations to be used for matching.

At block 406, the address match module 115 uses the multiplexer 222 to combine the subset of store operations according to a logical OR operation, thereby generating the address vector 112. At block 408, the compare module 225 compares each bit of the load address 103 having a value of 1 to the corresponding bit of the address vector 112. At block 410, the compare module 225 determines if each of the compared bits match. If so, the method moves to block 412 and the address match module 115 compares the load address 108 to the store address for each of the subset of store operations identified at block 404. In response to identifying a matching store address, the method flow moves to block 414 and the address match module 115 sends signaling to the STLF unit 118 to forward the store data for the identified store operation to the load operation 103.

Returning to block 410, if any of the bits compared at block 408 do not match, the method flow moves to block 416 and the address match module 115 ends the match process for the load operation 103. Thus, using the method 400, the address match module quickly and efficiently identifies when there is no match between the load operation 103 and any of the store operations at the store queue 106.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
combining a first plurality of store addresses associated with a plurality of store operations to generate an address vector; and
determining, based on the address vector, whether a load address associated with a load operation matches one of the first plurality of store addresses.

2. The method of claim 1, wherein the determining comprises:
identifying, based on the address vector, a potential match between the load address and the first plurality of store addresses; and
in response to identifying the potential match, comparing the load address to each of the first plurality of store addresses.

3. The method of claim 1, wherein the determining comprises:
identifying that the load address does not match any of the first plurality of store addresses based on the address vector.

4. The method of claim 1, wherein combining the first plurality of store addresses comprises:
combining the first plurality of store addresses by performing an OR operation for each corresponding bit of the first plurality of store addresses to generate the address vector.

5. The method of claim 4, wherein the determining comprises:
comparing each bit of the load address to a corresponding bit of the address vector.

6. The method of claim 5, wherein the determining comprises:
determining that the load address does not match any of the first plurality of store addresses in response to a specified state of a first bit of the load address differing from a state of a corresponding bit of the address vector.

7. The method of claim 1, further comprising:
selecting the first plurality of store addresses from a second plurality of store addresses prior to the combining.

8. The method of claim 1, further comprising:
performing a store-to-load forwarding operation based on the determining.

9. A method, comprising:
in response to receiving a load operation associated with a load address:
generating an address vector based on a combination of a plurality of store addresses associated with a plurality of store operations; and
identifying a potential match outcome between the load address and at least one of the plurality of store addresses based on the address vector.

10. The method of claim 9, further comprising:
in response to the potential match outcome indicating a potential match, comparing the load address to each of the plurality of store addresses to identify a store operation that matches the load operation.

11. The method of claim 10, further comprising:
forwarding data associated with the store operation to the load operation.

12. The method of claim 9, wherein generating the address vector comprises:
performing an OR operation for each corresponding bit of the plurality of store addresses to generate the address vector.

13. A processor comprising:
a load-store unit (LSU) including:
a queue to store a first plurality of store addresses associated with a plurality of store operations; and
an address match module to:
generate an address vector based on the first plurality of store addresses; and
determine, based on the address vector, whether a load address associated with a load operation matches one of the first plurality of store addresses.

14. The processor of claim 13, wherein the address match module is to determine whether the load address matches by:
identifying, based on the address vector, a potential match between the load address and the first plurality of store addresses; and
in response to identifying the potential match, comparing the load address to each of the first plurality of store addresses.

15. The processor of claim 13, wherein the address match module is to determine whether the load address matches by:
identifying that the load address does not match any of the first plurality of store addresses based on the address vector.

16. The processor of claim 13, wherein the address match module is to combine the first plurality of store addresses by:
performing an OR operation for each corresponding bit of the first plurality of store addresses to generate the address vector.

17. The processor of claim 16, wherein the address match module is to determine whether the load address matches by:
comparing each bit of the load address to a corresponding bit of the address vector.

18. The processor of claim 17, wherein the address match module is to determine whether the load address matches by:
determining that the load address does not match any of the first plurality of store addresses in response to a specified state of a first bit of the load address differing from a state of a corresponding bit of the address vector.

19. The processor of claim 13, wherein the address match module is to:
select the first plurality of store addresses from a second plurality of store addresses prior to the combining.

20. The processor of claim 13, wherein the LSU is to:
perform a store-to-load forwarding operation based on the determining.
